(19) United States
(12) Patent Application Publication
(10) Pub. No.: US 2008/0055684 A1
(43) Pub. Date: Mar. 6, 2008

(54) Method and device for controlling inner cavity color of medical imaging system

(75) Inventor: Feng Hua Li, Shenzhen (CN)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/897,374

(22) Filed: Aug. 30, 2007

(30) Foreign Application Priority Data
Aug. 30, 2006 (CN) 200610112691.X

(51) Int. Cl. H04N 1/46

(52) U.S. Cl. 358/534

(57) ABSTRACT

This invention proposes a method and a control device for controlling a medical imaging system's inner cavity color. The control device comprises a colored light source for lighting up the inner cavity of a medical imaging system so as to control its color tone. This colored light source is a base color light source and each base color light source is connected respectively to a regulator for regulating its brightness. A doctor or a patient can produce a mixture of lights of a desired color tone by controlling the brightness of each base color light source, while by illuminating the inner cavity of said medical imaging system with the mixture of lights said color tone will be presented therein. This invention can be widely used in all kinds of medical imaging systems, especially in magnetic resonance imaging systems and computerized tomography imaging systems.

### CROSS REFERENCE TO RELATED APPLICATIONS

This application claims priority of Chinese application No. 200610112691.X filed Aug. 30, 2006, which is incorporated by reference herein in its entirety.

### FIELD OF THE INVENTION

The present invention relates to a method and device for controlling color, especially to a method and device for controlling a medical imaging system's inner cavity color.

### BACKGROUND OF THE INVENTION

In certain enclosed environments, people may feel scared and frightened, commonly called claustrophobia.

In a medical imaging system, for example a high field magnetic resonance imaging system using a superconductive magnet, it has at its central part a circular inner cavity. When a patient is sent into said inner cavity for examination, due to its small inner space, if the examining time is relatively long the patient may feel scared, which may affect the patient's psychological status as well as the examination results, sometimes it may even leads to the interruption of the examination or the failure of the examination. For the same reasons, the similar cases also exist in case of a computerized tomography imaging system.

Currently, there are two ways to solve the above-described problem, one is to adopt an open design for said medical imaging systems by increasing the diameter of its inner cavity, thus to increase the view angle for observing, so that a patient in it will feel a larger space; the other one is to shorten the inner cavity length of the medical imaging system, so that a patient's head can come out of the inner cavity for as long as possible during some examinations, and the view angle will be wider so as to reduce the feeling of being enclosed.

However, the above-mentioned method of increasing the diameter of the inner cavity or reducing the length of the inner cavity has many drawbacks, for example, in a magnetic resonance imaging system, an increased diameter of the inner cavity requires to increase correspondingly the volume of magnets as well as to increase the intensity of corresponding signals, leading to significantly increased manufacturing costs; while a reduced length of the inner cavity requires a correspondingly reduced length of magnets, and the homogeneity of the magnetic field will thus be reduced and the imaging quality will also be affected thereby.

It will be a simple and effective method by using the inner cavity color of said medical imaging system to change the patient's psychological feeling so as to reduce or to eliminate claustrophobia or anxiety. Colors have important effects on a person's mental activity; particularly they have close relationship with a person's mood. When a patient is under examination in a closed inner cavity of a medical imaging system, it will provide significant effects in stabilizing her or his mood as well as in reducing or avoiding claustrophobia if he or she is in an environment of a favorite color.

The inner cavities of the early-stage medical imaging systems are black or has no lighting arrangement, so a patient may feel being trapped and tension may build up. The inner cavity of current medical imaging system is usually white, and is provided with lighting for illuminating the inner cavity.

However, in such current method of illuminating the white inner cavity by lighting lamps, the color of an inner cavity is unchangeable, and a doctor or a patient cannot select a different color according to practical needs or favor. For this reason, how to provide a convenient and simple method and device for controlling the inner cavity color of a medical imaging system has become a problem in the manufacturing and usage of medical imaging systems.

### SUMMARY OF THE INVENTION

An object of this invention is to propose a method and device for controlling the inner cavity color of a medical imaging system, for simple and convenient control of the color of said inner cavity.

To achieve the above-mentioned object, this invention proposes a method for controlling the inner cavity color of a medical imaging system by using at least one colored light to light up the inner cavity of a medical imaging system so as to control the color of the inner cavity.

Said at least one colored light is a base color light, and by regulating the brightness of each base color light the color tone of the mixed lights is controlled. By keeping the brightness of various regulated base color lights constant it is produced by the mixture the lighting of a specific color tone; or by continuously regulating the brightness of at least one base color light it is produced by the mixture the lighting of a dynamically changing color tone.

Correspondingly, this invention proposes a device for controlling the inner cavity color of a medical imaging system, comprising at least one colored light source for illuminating the inner cavity of a medical imaging system so as to control the color thereof.

Said at least one colored light source is connected to a respective switch, said switch is used to control the turning-on and turning-off of the colored light source connected to it.

Said at least one colored light source is a base color light source, with each base color light source connected to a respective regulator, and with said regulator being used to regulate the brightness of the base color light source connected to it. Said base color light source comprises a red color light source, a blue color light source and a green color light source.

A doctor or a patient can have the lighting of a desired mixture of colors by controlling the brightness of each base color light source, while by illuminating the inner cavity of said medical imaging system with the mixture of lights said color tone will be presented therein.

The method and device of this invention can be widely used in all kinds of medical imaging systems, particularly in magnetic resonance imaging systems and computerized tomography imaging systems.

### BRIEF DESCRIPTION OF THE DRAWINGS

The invention is explained in more detail with the following drawings, in which,

FIG. 1 is an illustration of an embodiment of the device for controlling the inner cavity color of a medical imaging system according to the invention;

FIG. 2 is an illustration of another embodiment of the device for controlling the inner cavity color of a medical imaging system according to the invention.

### DETAILED DESCRIPTION OF THE INVENTION

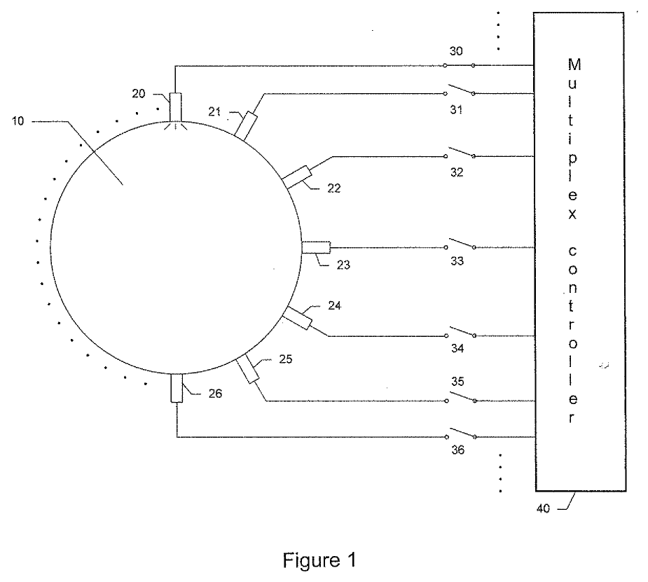

Refer to FIG. 1, in an embodiment of the invention, it is provided in an inner cavity 10 of a medical imaging system at least one colored light source such as colored light sources 20, 21, 22, 23, 24, 25, 26 etc. shown in the figure, for illuminating the inner cavity 10 so as to control its color. Wherein, said colored light sources 20˜26 can be selected as light emission diodes which emit corresponding colored lights after being energized, and their number and fitting positions can be selected according to practical needs.

Each of said colored light sources 20˜26 emits a light of a specific color, namely a colored light, for illuminating the inner cavity 10 of said medical imaging system so as to make it presenting the color tone of the colored light. Each of said colored light sources 20˜26 is connected respectively to a switch, such as switches 30, 31, 32, 33, 34, 34, 36 etc. shown in the figure, and by switching on and switching off said switches 30˜36 the turning-on and turning-off of the colored light sources 20˜26 respectively connected thereto can be controlled. As shown in the figure, when the switch 30 is switched on while the switches 31˜36 are switched off, the colored light source 20 is turned on and emits corresponding colored light to illuminate the inner cavity 10 to make it presenting a corresponding color, while the colored light source 21˜26 are in the status of being turned-off.

Said switches 30˜36 can also be further connected to a multiplex controller 40, and by this multiplex controller 40 a doctor or a patient can conveniently control the switching-on or switching-off of said switches 30˜36 respectively, so as to achieve the purpose of conveniently control the color tone of the inner cavity 10.

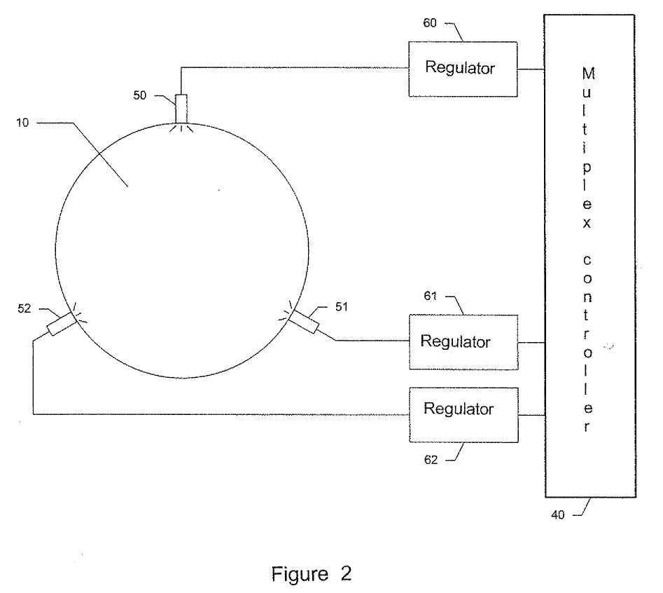

Refer to FIG. 2, in another embodiment of this invention, it is provided in the inner cavity 10 at least one colored light source, preferably, three colored light sources 50, 51, 52. Said colored light sources 50, 51, 52 can be selected as light emission diodes which emit corresponding colored lights once being energized.

Each of the above-mentioned colored light sources 50˜52 emits a light beam of a specific color, namely a colored light, preferably said colored light sources 50˜52 are base color light sources, emitting respectively a base color light. After said base color lights of different brightness are mixed together, they will produce a lighting of a desired color tone, so as to achieve the purpose of controlling the color tone of the inner cavity 10.

In this embodiment, the mixing of said base color lights is performed by using an RGB mode, that is, said base color light sources 50˜52 are respectively selected as a red colored light source, a green colored light source and a blue colored light source, which emit correspondingly the red colored light, the green colored light and the blue colored light.

Since in the RGB mode, the mixing of the base color lights of different brightness with one another can produce lighting of different color tones. The brightness of a colored light is usually divided into 0˜255, a total of 256 different values, therefore, by using these three base color lights of red, green and blue at different brightness levels to mix together, a total of 256×256×256=16,777,216 different lighting color tones can be produced.

When two or more than two colored lights are mixed, they will simultaneously or in a extremely short time stimulate continuously the eyes of a person, letting the person have the sense of a new color, and this method of mixing colored lights is commonly called the color additive method. For example the three base color lights of red, green and blue being mixed together at equal proportions will produce white light, that is (R)+(G)+(B)=(W); two base color lights of red and blue mixed together at equal proportions will produce yellow light, that is (R)+(B)=(Y); and familiar color mixtures are shown in the following table:

| | | Color | | | | | | | |
|---|---|---|---|---|---|---|---|---|---|
| | | Cyan | Magenta | Yellow | Red | Green | Blue | White | Black |
| RGB value | R | 0 | 255 | 255 | 255 | 0 | 0 | 255 | 0 |
| (0~255) | G | 255 | 0 | 255 | 0 | 255 | 0 | 255 | 0 |
| | B | 255 | 255 | 0 | 0 | 0 | 255 | 255 | 0 |

Therefore, a doctor or a patient can produce a lighting of a desired color tone by controlling the brightness values of said three base color lights of red, green and blue, so as to control the color of the inner cavity of said medical imaging system.

Said red, green and blue light sources 50, 51, 52 are connected respectively to regulators 60, 61, 62. Said regulators 60, 61, 62 are used to regulate the brightness of the base color light sources connected to them, then by keeping the regulated brightness of each base color light constant it can produce by the mixture a lighting of a specific color tone. Said regulators 60, 61, 62 can be, for example, rheostats connected to said base color light sources, and by changing their resistances the voltages applied on said base color light sources are changed, so as to achieve the controlling of the brightness levels of the base color lights emitted by said base color light sources.

Furthermore, it can also maintain the brightness of a number of base color light sources unchanged, while regulating at least one of the base color light sources to make its brightness changing continuously with time, so as to obtain a mixed lighting of a continuously changing color tone.

Said regulators 60, 61, 62 are respectively connected to a multiplex controller 40, so a doctor or a patient can conveniently control the brightness of various base color light sources via said multiplex controller 40 so as to produce a mixed lighting of a desired color tone, while said mixed lighting will illuminate the inner cavity of said medical imaging system for presenting said color tone.

During the practical application of this invention, said colored light sources can be further used to compose various patterns, and at the same time of achieving the control of the color of said inner cavity music can be played in coordination to increase the patient's degree of comfort.

The method and device of this invention can be widely used in all kinds of medical imaging systems, particularly in magnetic resonance imaging systems and computerized tomography imaging systems.

1.-10. (canceled)

11. A method for controlling a color of an inner cavity of a medical imaging system, comprising:
lighting up the inner cavity with a colored light; and
regulating the colored light for controlling the color of the inner cavity.

12. The method as claimed in claim 11, wherein the colored light comprises a plurality of base color lights.

13. The method as claimed in claim 12, wherein a color tone of a mixed light from the base color lights is controlled by regulating a brightness of each of the base color lights.

14. The method as claimed in claim 13, wherein the color tone of the mixed light is kept constant by keeping the brightness of each of the base color lights constant.

15. The method as claimed in claim 13, wherein the color tone of the mixed light is continuously changed by continuously regulating a brightness of at least one of the base color lights.

16. The method as claimed in claim 13, wherein the base color lights are selected from the group consisting of: red color light, blue color light, and green color light.

17. A method for controlling a color of an inner cavity of a medical imaging system, comprising;
lighting up the inner cavity with a plurality of base color lights;
generating a mixed light from the base color lights;
controlling a color tone of the mixed light by regulating a brightness of each of the base color lights.

18. The method as claimed in claim 17, wherein the color tone of the mixed light is kept constant by keeping the brightness of each of the base color lights constant.

19. The method as claimed in claim 17, wherein the color tone of the mixed light is continuously changed by continuously regulating a brightness of at least one of the base color lights.

20. The method as claimed in claim 17, wherein the base color lights are selected from the group consisting of: red color light, blue color light, and green color light.

21. A device for controlling a color of an inner cavity of a medical imaging system, comprising:
a colored light source having an adjustable color that illuminates the inner cavity.

22. The device as claimed in claim 21, wherein the colored light source is connected to a switch for turning the colored light source on and off.

23. The device as claimed in claim 21, wherein the colored light comprises a plurality of base color lights each connected to a regulator.

24. The device as claimed in claim 23, wherein the regulator regulates a brightness of the respectively connected base color light source.

25. The device as claimed in claim 21, wherein the base color light sources are selected from the group consisting of: a red color light source, a blue color light source, and a green color light source.

26. The device as claimed in claim 21, wherein the medical imaging system is a magnetic resonance imaging system or a computerized tomography imaging system.
